(19) United States
(12) Patent Application Publication
(10) Pub. No.: US 2015/0017928 A1
(43) Pub. Date: Jan. 15, 2015

(54) OVER-THE-AIR TESTING OF WIRELESS DEVICES USING LOG FILES

(71) Applicant: Azimuth Systems, Inc., Acton, MA (US)

(72) Inventors: John Robert Griesing, Sudbury, MA (US); Shabbir A. Bagasrawala, Westford, MA (US)

(73) Assignee: Azimuth Systems, Inc., Acton, MA (US)

(21) Appl. No.: 14/327,356

(22) Filed: Jul. 9, 2014

Related U.S. Application Data
(60) Provisional application No. 61/843,987, filed on Jul. 9, 2013.

(51) Int. Cl. H04B 17/00

(52) U.S. Cl. CPC H04B 17/0007
USPC 455/67.14

(57) ABSTRACT

An over-the-air test system for wireless devices uses log files to simulate realistic time-varying channel conditions and provides channel state information to enable dynamic adaptation to current channel conditions. A signal transmission device transmits test signals to the device under test via a channel emulator. The channel emulator causes the test signals to exhibit channel conditions which vary over time. An over-the-air test chamber in which the device under test is disposed includes multiple antennas which are driven with the test signals from the channel emulator. Channel state information is sent from the device under test to the signal transmission device. The signal transmission device responds to the channel state information by adapting to current channel conditions.

### CROSS-REFERENCE TO RELATED APPLICATIONS

This application claims the benefit of U.S. Provisional Application No. 61/843,987 filed Jul. 9, 2013, titled MIMO OTA Playback of Field Data for Device Performance Prediction in the Real World, which is incorporated by reference.

### BACKGROUND

The subject matter of this disclosure is generally related to testing of wireless devices. A wide variety of wireless devices exist. Examples include, but are not limited to, mobile phones, base stations, wireless routers, cordless phones, personal digital assistants (PDAs), consumer electronic devices, networking equipment, desktop computers, tablet computers, and laptop computers. Testing of a wireless device may be desirable for any of various reasons. For example, testing can be done in the development stage in order to determine whether a prototype wireless device functions as designed and meets design specifications. Testing may also be useful for determining whether the production of the wireless devices perform within specifications and the device has been manufactured properly. Testing may also be employed post deployment of the wireless device for the purposes of performance monitoring and fault resolution.

Testing of a wireless device under conditions of which it would experience in actual real world deployments allows for advantages in design optimization, performance prediction and fault resolution. Testing of a wireless device in a controlled and repeatable way, in a manner in which it is used in the real world and under realistic conditions, is challenging. In a real world deployment manner, wireless devices are operated with and using the antennas. It is known to perform open-air testing of mobile wireless devices by operating the wireless Device Under Test (DUT) while moving the DUT within a partly or completely uncontrolled environment while measuring various performance parameters. Open-air testing advantageously indicates how the DUT performs in its native state in a real network environment. In open air testing the device is subjected to signals arriving from a multitude of directions as the device moves through the environment. Repeated testing of the device, even under similar conditions, may not create the same specific signal directions, but one might expect to observe conditions that are statistically the same. The reason for such specific differences can be related to any change such as exact position of travel, exact holding of the device, weather conditions, interference, and other items that can impact specifics over which there is limited to no control in an open air environment. Open-air testing suffers from testing in an uncontrolled environment. Uncontrolled behavior of the overall wireless network, interference sources or other conditions that can influence the behavior of the wireless device can render the results unpredictable. Performing many open air tests in a variety of channel conditions, time of day, etc. may allow for a better statistical view of how the wireless DUT performs. As signal direction, position of device relative to the user and the signal, and other uncontrolled events can occur, many samples are required. But such a process can be too labor intensive to run repeated trials under a wide variety of traffic conditions, distances between devices rates of motion, interference, traffic patterns, etc.

It is also known to perform over the air testing, operating the wireless DUT under controlled conditions in a laboratory. Over the air testing in the laboratory for a mobile wireless DUT is traditionally performed to measure characteristics of the antenna used in conjunction with the host radio device. Such testing may employ conditions that are suitable for some direct measurement of performance but are not directly representative of a real world environment. Additionally, over the air laboratory testing may be performed using channel models to represent the statistics of certain radio propagation conditions. Such testing may be employed using approaches that couple a radio propagation channel emulator to an over the air chamber, such as a reverberation chamber or an anechoic chamber.

Anechoic chambers are used to precisely control the angle of arrival(s) of the radio waves reaching the wireless DUT. Such testing is typically employed in specific antenna measurements, such as antenna patterning. An anechoic chamber can be combined with a channel emulator for adding radio propagation conditions. The conditions created by the channel emulator and anechoic chamber provide a more realistic environment. But as the signal arrive at the DUT is very precise, a large number of orientations of the DUT may be necessary to evaluate a real world operation and such testing can be very time consuming. Also, the anechoic chambers are relatively large and costly.

It is also known to perform OTA testing in a reverberation chamber. A reverberation chamber has walls that reflect electromagnetic waves so a signal transmitted within the chamber tends to reverberate, launching many modes in the chamber that subsequently result in plane waves. Moveable mechanical devices called “stirrers” are used to change the amplitude and phase of the plane waves. The mechanical stirrers also produce a Doppler shift in the chamber.

Reverberation chambers have the advantage of generally requiring less physical space than anechoic chambers. They also have the advantage that they can produce a condition of isotropy, where the distribution of plane waves arriving at the device under test located in the chamber is observed to be statistically uniform. This has advantage in device evaluation where there are many reflections, such as found in real world environments. However due to the practical speed limits of the stirrers, reverberation chambers are not well suited to providing Doppler conditions similar to those experienced by a mobile wireless device in rapid motion in a real environment, such as might occur when travelling in an automobile or train. Furthermore, the average reverberation chamber impulse response is a simple decaying exponential, which is different from actual channel conditions where reflections of varying power and delay may reach the mobile wireless device which are not at all characteristic of single exponential decay. Consequently, testing with reverberation chambers is generally limited to producing conditions of low Doppler frequencies and simple decaying exponential power delay profiles, or for testing that does not require realistic channel conditions.

### SUMMARY

In accordance with an aspect, an apparatus for testing a wireless device with at least one antenna comprises: a signal transmission device which transmits test signals having a spatial rank; a channel emulator which operates on the test signals from the signal transmission device to cause the test signals to exhibit channel conditions which vary over time; and an over-the-air test chamber including multiple antennas which are driven with the test signals from the channel emulator which exhibit channel conditions, the device under test being disposed in the over-the-air test chamber and sending channel state information to the signal transmission device, the signal transmission device responding to the channel state information by adapting to current channel conditions.

In some implementations the over-the-air test chamber is a reverberation chamber, and the driven antennas deployed in the reverberation chamber are greater in number than the spatial rank of the test signals from the multiple antennas being received by the at least one antenna of the wireless device.

In some implementations the channel emulator has a greater number of outputs to the driven antennas than inputs from the signal transmission device.

In some implementations the channel emulator independently drives the outputs with different fading processes.

In some implementations the fading processes are random.

In some implementations the antennas are deployed in the reverberation chamber such that no line-of-sight transmission component exists from test system antennas to the at least one antenna of the wireless device under test.

In some implementations the antennas are deployed in the reverberation chamber such that there is a line of sight component from at least one test system antenna to the at least one antenna of the wireless device under test.

In some implementations the antennas are deployed in the reverberation chamber such that that signals from the antennas are directed away from the device under test.

In some implementations the signal transmission device emulates one or more of an actual base station device, a base station emulator, a femtocell, a picocell, a class of base station device, an access point, an access point emulator, or a programmable signal generator.

In some implementations the channel emulator provides a dominant Doppler source relative to a Doppler source of the reverberation chamber.

In some implementations the Doppler process of the reverberation chamber is in some ratio of the Doppler process of the channel emulator.

In some implementations when a desired fading or Doppler velocity is set, the apparatus adjusts the velocity of a stirring process of the chamber to maintain the ratio.

In some implementations the signals emanating from the driven antennas are correlated according to settings in the channel emulator.

In some implementations the channel emulator provides a statistical representation of channel propagation conditions for evaluation of the wireless device, wherein the conditions include at least one of multipath, correlation, and fading.

In some implementations the chamber includes absorbing material which dampens reverberation such that the channel emulator provides the dominant multipath conditions.

In some implementations automated calibration determines decay of the chamber.

In some implementations the signal transmission device is a device emulator.

In some implementations a sniffer antenna inside the test chamber enables the wireless device under test to provide the channel state information to the signal transmission device.

In some implementations a sniffer antenna inside the test chamber enables the wireless device under test to respond to the test signal by negating effects of the chamber on a signal transmitted by the device under test which are undesirable for the test.

In some implementations signal data is analyzed to determine a metric including at least one of throughput, packet loss, error rate, and Channel Quality Information.

In accordance with another aspect, a method for testing a wireless device with at least one antenna comprises: generating test signals having a spatial rank; causing the test signals to exhibit channel conditions which change over time; driving multiple antennas in an over-the-air test chamber with the test signals from the channel emulator which exhibit channel conditions, the device under test being disposed in the over-the-air test chamber; and sending channel state information to the signal transmission device, the signal transmission device responding to the channel state information by adapting to current channel conditions.

In some implementations the method includes, wherein the over-the-air test chamber is a reverberation chamber, deploying the driven antennas in the reverberation chamber in greater number than the spatial rank of the test signals from the multiple antennas being received by the at least one antenna of the wireless device.

In some implementations the method includes utilizing a greater number of channel emulator outputs to the driven antennas than inputs from the signal transmission device.

In some implementations the method includes the channel emulator independently driving the outputs with different fading processes.

In some implementations the method includes causing the fading processes to be random.

In some implementations the method includes deploying the antennas in the reverberation chamber such that no line-of-sight transmission component exists from test system antennas to the at least one antenna of the wireless device under test.

In some implementations the method includes deploying the antennas in the reverberation chamber such that there is a line of sight component from at least one test system antenna to the at least one antenna of the wireless device under test.

In some implementations the method includes deploying the antennas in the reverberation chamber such that that signals from the antennas are directed away from the device under test.

In some implementations the method includes the signal transmission device emulating one or more of an actual base station device, a base station emulator, a femtocell, a picocell, a class of base station device, an access point, an access point emulator, or a programmable signal generator.

In some implementations the method includes the channel emulator providing a dominant Doppler source relative to a Doppler source of the reverberation chamber.

In some implementations the method includes causing the fading process of the reverberation chamber to be in some ratio of the fading process of the channel emulator.

In some implementations the method includes, when a desired fading or Doppler velocity is set, adjusting the velocity of a stirring process of the chamber to maintain the ratio.

In some implementations the method includes correlating the signals emanating from the driven antennas according to settings in the channel emulator.

In some implementations the method includes the channel emulator providing a statistical representation of channel propagation conditions for evaluation of the wireless device, wherein the conditions include at least one of multipath, correlation, and fading.

In some implementations the method includes providing the chamber with absorbing material which dampens reverberation such that the channel emulator provides the dominant multipath conditions.

In some implementations the method includes determining decay of the chamber with automated calibration.

In some implementations the method includes the signal transmission device being a device emulator.

In some implementations the method includes a sniffer antenna inside the test chamber enabling the wireless device under test to provide the channel state information to the signal transmission device.

In some implementations the method includes a sniffer antenna inside the test chamber enabling the wireless device under test to respond to the test signal by negating effects of the chamber on a signal transmitted by the device under test which are undesirable for the test.

In some implementations the method includes analyzing signal data to determine a metric including at least one of throughput, packet loss, error rate, and Channel Quality Information.

In accordance with another aspect apparatus for testing a wireless device with at least one antenna comprises: a signal transmission device which transmits test signals having a spatial rank; a channel emulator which operates on the test signals from the signal transmission device to cause the test signals to exhibit channel conditions which vary over time; and an over-the-air test chamber including multiple antennas which are driven with the test signals from the channel emulator which exhibit channel conditions, the device under test being disposed in the over-the-air test chamber and undergoing a first test in which the signal transmission device is in a first mode and a second test in which the signal transmission device is in a second mode, results of the tests being used to estimate adaption to current channel conditions.

In accordance with another aspect a method for testing a wireless device with at least one antenna comprises: generating test signals having a spatial rank; causing the test signals to exhibit channel conditions which change over time; driving multiple antennas in an over-the-air test chamber with the test signals from the channel emulator which exhibit channel conditions, the device under test being disposed in the over-the-air test chamber; performing a first test in which the signal transmission device is in a first mode and a second test in which the signal transmission device is in a second mode; and using results of the tests being used to estimate adaption to current channel conditions.

### BRIEF DESCRIPTION OF THE FIGURES

FIG. 1 illustrates a system for OTA testing of a wireless device.

FIG. 2 illustrates aspect of playback file generation.

FIG. 3 illustrates aspects of the channel emulator and signal transmission devices.

FIG. 4 illustrates the OTA test chamber.

FIG. 5 illustrates multimodal operation.

FIG. 6 illustrates a method of testing when the signal transmission device has the capability to dynamically adapt to changing channel conditions.

FIG. 7 illustrates a method of testing when the signal transmission device does not have the capability to dynamically adapt to changing channel conditions.

### DETAILED DESCRIPTION

Some aspects may be implemented by one or more computer programs. Such computer programs are stored in non-transitory computer-readable memory and executed by physical processing hardware in physical apparatus to perform various tasks. Moreover, the features described below can be used in any of a wide variety of combinations that are not limited to the illustrated and described examples.

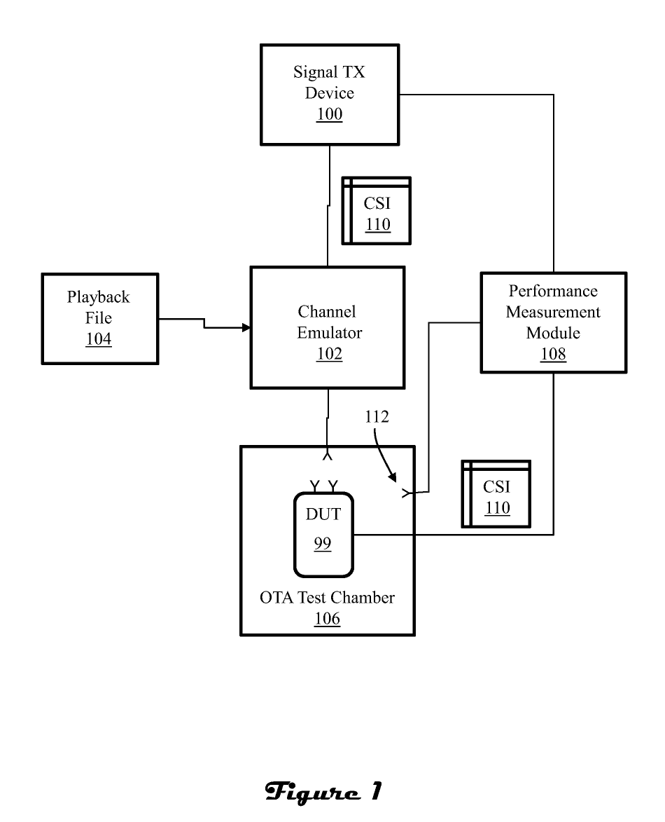

FIG. 1 illustrates an OTA test system for a wireless DUT 99. The OTA test system includes a signal transmission device 100, a channel emulator 102, a playback file 104, an OTA test chamber 106, and a performance measurement module 108. In order to conduct a test, the signal transmission device 100 transmits signals to the DUT 99 via the channel emulator 102. The signal transmission device may also receive signals from the DUT via the channel emulator. The channel emulator 102 processes the signals which it receives by subjecting those signals to simulated channel conditions. In particular, the channel emulator recreates channel conditions specified by the playback file 104. Channel state information (CSI) 110 is sent to the signal transmission device from the DUT, e.g., via the channel emulator or performance measurement module. The CSI indicates aspects of the signal received from the signal transmission device by the DUT, e.g., without limitation, CSI may include spatial rank, block error rate, and requested modulation coding scheme. The CSI potentially enables the signal transmission device to adapt transmissions to current channel conditions as channel conditions change over time and the DUT's ability to receiver under such conditions. For example, the signal transmission device may respond to the CSI by changing modes, which may include changing configuration parameters. Performance measurements gathered during the test may be used to evaluate the DUT. For example, performance parameters captured from or by the DUT, such as data rate or throughput for example and without limitation, may be provided to the performance measurement module for storage and analysis. The signal transmission device may also provide a signal to the performance metric measurement module for storage and analysis. It should be noted that the measurement module 108 is not used in every configuration. Various functions, features and aspects that may be associated with these and other components are described in greater detail below.

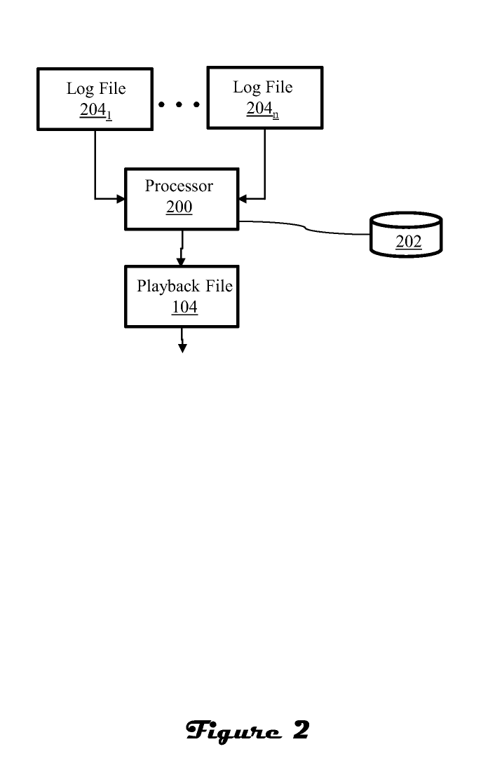

Referring to FIGS. 1 and 2, the playback file 104 is generated by a physical processor device 200 using program code stored in non-transitory computer-readable memory 202. The playback file is produced from one or more log files 204₁ through 204ₙ which are recorded by actual wireless devices during use in a real communication network environment. For example, the log files may be created by base stations and mobile phones operating in their native state in an open-air environment over a period of time. The logs may be recorded under general conditions to be tested, e.g., driving in a rural setting, walking in an urban setting, and passing near to obstructions and wireless hot spots. Network performance indicators recorded in the log files may include but are not limited to one or more of power measurements (e.g., interference, noise, signal-to-noise ratio (SNR), reference signal received power (RSRP), reference signal received quality (RSRQ), received signal strength indicator (RSSI), and multipath Power-Delay-Profile), multiple-input multiple-output (MIMO) correlation, cell information, sector information, location information, data rate, throughput, wireless channel signal quality, and handoff parameters. It should be noted that the playback file may represent one or more selected portions of interest from the log files. For example, portions of the log files may be selected because they contain an event such as a call drop, handover, sub-optimal capacity, sub-optimal QoS, sub-optimal coverage, resource management issues, or where unique modulation, channel quality information (CQI) power measurement, reporting, or resource block distribution patterns occur. The channel conditions described in the playback file are simulated by the channel emulator.

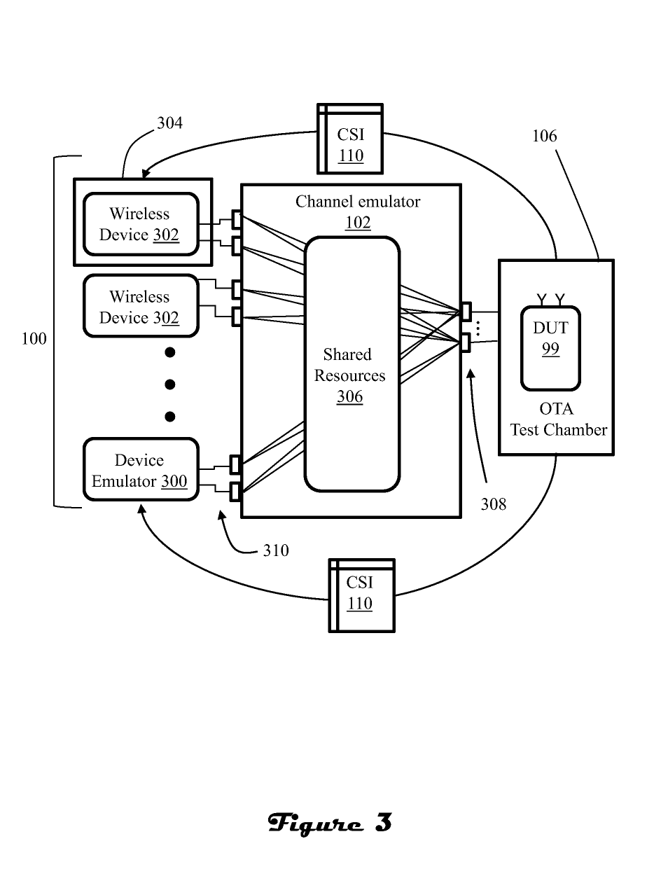

Referring to FIGS. 1 and 3, a wide variety of wireless devices may be employed as the signal transmission device 100. For example and without limitation, the signal transmission device 100 may include one or more of a device emulator 300 and actual wireless devices 302 such as a wireless base station, wireless router, and mobile phone. The device emulator 300 may be specialized to emulate a particular device or type of device, or have more general capabilities to emulate the transmission of a signal that is typically received by the DUT 99 or will be received by the DUT in some test mode for the purpose of evaluation. Devices which the device emulator 300 may emulate include, but are not limited to, a base station, femto cells, pico cells, and an access point. The signal transmission device may be able to operate in different transmission modes, modulations and coding schemes. Depending on the type of signal transmission device being used, the signal transmission device may be disposed in an EMI-shielded container 304 and its antennas may be bypassed with wired connections to the channel emulator 102. A wide variety of EMI-shielded containers may function as the test chamber for the signal transmission device. When multiple signal transmission devices are used it is possible to create handover situations in which the DUT changes from being affiliated with a first signal transmission device to being affiliated with a second transmission device.

The channel emulator interconnects 102 the signal transmission device 100 with the DUT 99 and recreates channel conditions which are described by the network parameters in playback file 104. The channel conditions are recreated using shared resources 306 which can be controlled to manipulate aspects of the signals to simulate the channel conditions described by the playback file. The shared resources may include various power attenuators and digital signal processing capabilities, among a wide variety of possibilities. The channel conditions which may be simulated by the shared resources based on the network parameters may include but are not limited to multipath reflections, delay spread, angle of arrival, power angular spread, angle of departure, antenna spacing, antenna geometry, Doppler from moving vehicle, Doppler from changing environments, path loss, shadow fading effects, reflections in clusters and external interference such as radar signals, phone transmission and other wireless signals or noise. Other channel conditions which may be recreated by the channel emulator include but are not limited to number of available sectors and pilot signals, power of the pilot signals, received power levels, signal-to-noise-plus-interference ratio (SNIR), and hand-off situations. These conditions can be used to evaluate aspects of network, device and DUT performance such as average sector throughput, average delay, average network throughput, and the performance of different traffic types such as best effort (BE), expedited forwarding (EF), and assured forwarding (AF). The number of output ports 308 of the channel emulator 102 may be greater than the number of transmit ports 310 of the signal transmission device. Furthermore, the output ports of the channel emulator 102 may be independently driven by different fading processes which may be random. The fading condition is characterized by multiple copies of the signal constructively or destructively adding and arriving at the DUT 99, so the different fading processes tend to create a more Gaussian process at the DUT.

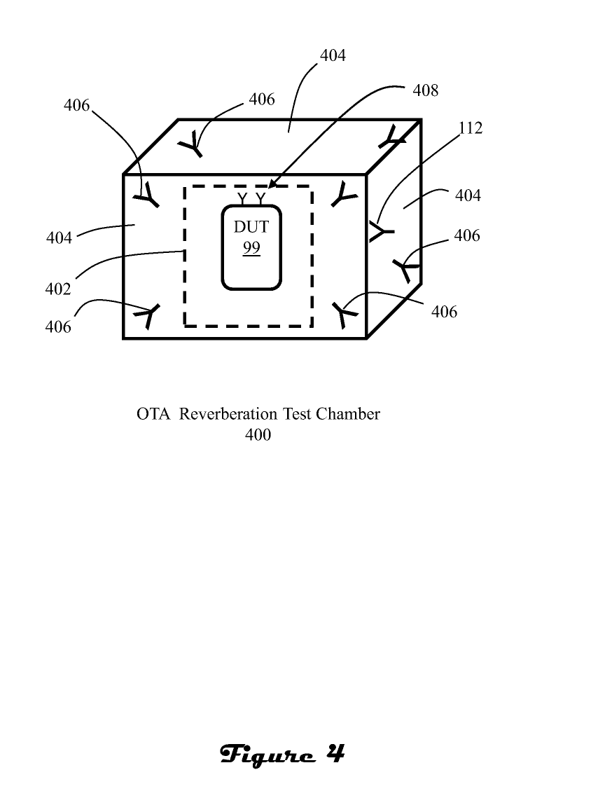

Referring to FIGS. 1 and 4, the OTA test chamber 106 may be a type of reverberation chamber 400 which includes a door 402 and walls 404 that reflect electromagnetic waves within the chamber such that a signal transmitted within the chamber tends to reverberate. The reverberation chamber may include moveable mechanical devices such as so-called “stirrers.” The stirrers help to create test signals characterized by isotropy or uniform angle of arrival (AoA) relative to the DUT. The number of antennas 406 deployed in the reverberation test chamber 400 and placement of those antennas 406 can be selected to produce a Ricean or Rayleigh (rather than Double Rayleigh) fading. The chamber 400 produces Rayleigh fading provided that certain conditions are met related to the size of the chamber and frequency of operation. The channel emulator 102 is able to produce Rayleigh fading. If the two operations are cascaded then the result will be a fading with an amplitude distribution that is characterized as Double Rayleigh. A Double Rayleigh distribution is undesirable when characterizing DUT performance under typical real world channel conditions that are understood to be statistically represented as Rayleigh. The use of multiple antenna 406 paths, greater in number than the spatial rank of the system and that have independent fading paths, randomizes the process and produces the desired Rayleigh fading. The chamber 400 is not limited to a particular number of antennas or paths, but the number of independent fading paths should be greater than the spatial rank of the signal in accordance with an aspect. Further, the corresponding antennas 406 may be deployed in the OTA reverberation test chamber 400 such that there are one or more fading paths per antenna 406 as provided by the channel emulator. The antennas may be driven through external amplifiers to provide necessary gain to account for all losses of the system. Further, the antennas 406 may be deployed such that no line-of-sight transmission component exists from each test system antenna to DUT antennas 408 in order to create Rayleigh fading. This is accomplished by positioning the antennas 406 such that signals are directed away from the DUT 99, e.g., into the corners of the test chamber 400. Deploying the antennas 406 with a line-of-site transmission component creates Ricean fading.

The fading process of the OTA reverberation test chamber 400 may be in some predetermined ratio relative to the fading process of the channel emulator 102. An automatic control system may be employed such that when a desired fading or Doppler velocity is set, the system adjusts the velocity of the stirrers of the chamber to maintain the ratio. Furthermore, the chamber may be loaded with absorbing material which dampens reverberation such that multipath conditions dominate from the channel emulator. It is also possible to run an automated calibration to determine the exponential decay of the chamber. Decay of the chamber can be mechanically or electronically controlled, e.g., dynamically controlled to adjust decay of the chamber. Furthermore, the channel emulator can be used to send a signal and measure the response of the signal for the purposes of measuring the decay of the chamber.

Referring now to FIGS. 1 through 4, the outputs 308 of the channel emulator 102 each drive one of the antennas 406 that are mounted inside the OTA test chamber 106. Signals from these antennas 406 are received by the DUT 99 via antennas 408. Simultaneously driving multiple antennas 406 and moving the DUT on a turntable helps to create an isotropic environment. The OTA test chamber provides limited Doppler based on mechanical movements. A sniffer antenna 112 associated with the test chamber may provide a return signal from the DUT 99 to the signal transmission device 100, e.g., via the performance measurement module 108.

The combination of the channel emulator 102 and OTA test chamber 106 can provide the responses typically experienced as delayed copies of reflected transmitted signals, i.e., variable multipath delay elements. The channel emulator 102 can be programmed in such a way as to create specific channel conditions in the test chamber. The channel emulator can be programmed for a specific power delay profile, with each cluster representing a tap in the model. The exponential decay of the cluster reflection can be modeled by the reverberation chamber with the appropriate loading of the chamber. For each path or tap of the power delay profile, a correlation can be programmed via the channel emulator to provide a correlation between signal (driven antenna) paths for each major cluster. The correlation will be dependent on the model including the correlation of the transmitting side. The characteristics of the fading can be programmed in the channel emulator for emulating variable speed of the DUT environment. The fading of the channel emulator is mapped such that the combined process of the channel emulator and OTA test chamber provide fading that closely statistically matches that of a desired model. Furthermore, the Doppler created by the channel emulator is selected to be dominant as compared to that of the reverberation chamber, e.g., where the Doppler created by the channel emulator is X then chamber Doppler is a small fraction of X. The channel emulator also provides controlled correlation as presented to the DUT by imparting a “transmit side” correlation, controlling the multipath delay pattern at the DUT, and creating a Power Delay Profile.

The performance metric measurement module 108 functions to measure performance metrics in response to the output of the DUT 99 and possibly the signal transmission device 100. Metrics such as throughput, packet loss, and error rate can be determined to evaluate performance and reliability of the DUT in the OTA test system. Channel Quality Information reported by the DUT could also be a performance metric. Other metrics can also be determined based on channel conditions, signal strength, DUT position and other parameters the system is capable of generating. The measured metrics may be stored in non-transitory memory, presented via a display or interface, and provided to the signal transmission emulator.

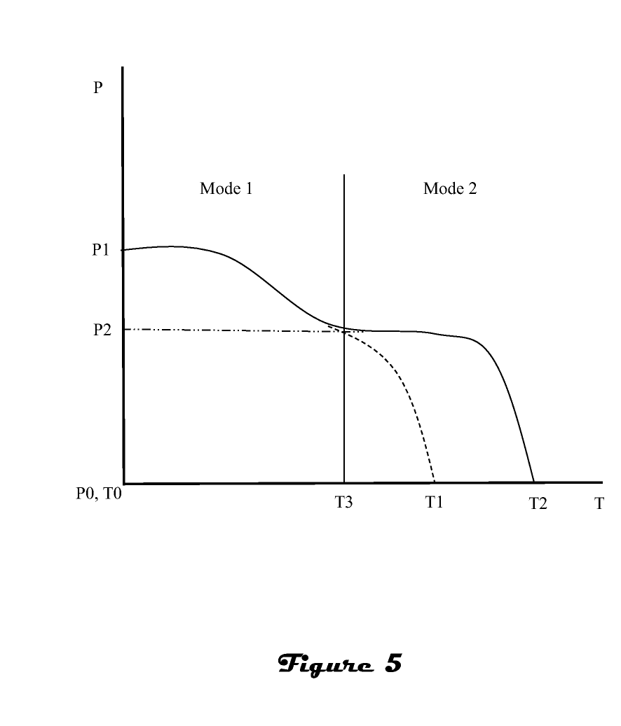

An aspect of providing CSI from the DUT to the signal transmission device is illustrated in FIG. 5, which depicts throughput reported by the DUT over time. In mode 1 (from T0 to T3) the throughput level begins at P1 and approaches P0 at T1. In mode 2 (from T3 to T2) the throughput level begins at P2 and approaches P0 at T2. The signal transmission device utilizes the CSI 110 (FIG. 1) provided by the DUT to determine when to transition between modes, e.g., at T3. In other words the signal transmission device dynamically adapts to changing channel conditions, resulting in a power level that begins at P1 and approaches P0 at T2. Post processing, e.g., by the performance measurement module, can be used to identify individual performance modes. In the absence of CSI the signal transmission device would not adapt to changing channel conditions. Consequently, this more realistic response is not produced by prior art systems which do not utilize CSI.

Some signal transmission devices may not have the capability of responding to some or all CSI parameters. In such cases a dynamic adaptation response may be estimated by manually adjusting or reconfiguring the signal transmission device, e.g., between different tests performed with different parameters. An estimated dynamic adaptation response is then calculated from the results of the individual tests. For example, the functions associated with Mode 1 and Mode 2 in FIG. 5 could be results from independent tests of a base station emulator without a corresponding CSI response capability. Separate tests would be run with different base station emulator settings corresponding to mode 1 and mode 2. The results of the tests would then be compared and the maximum value of P selected in order to estimate dynamic adaptation response. Alternatively, or in combination, a transition time between modes, e.g., T3, could be selected and P values could be used from the different individual tests before and after the selected transition time.

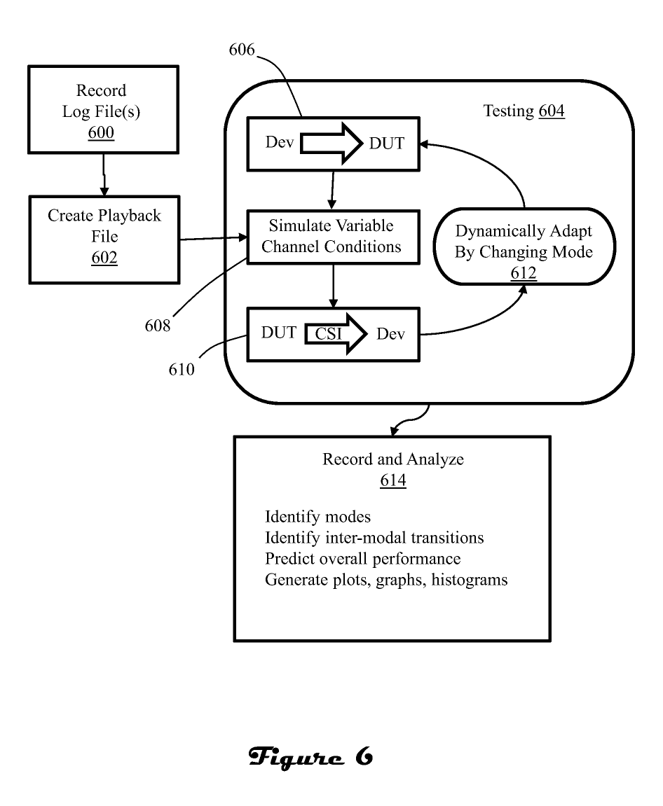

A method of performing OTA testing is shown in FIG. 6. Initial steps which may be performed prior to testing include recording at least one log file 600 and creating a playback file 602. During testing 604 the signal transmission device sends communications to the DUT via the channel emulator as shown in step 606 while the channel emulator simulates variable channel conditions as shown in step 608. The DUT transmits CSI to the signal transmission device based on the received signals as shown in step 610. The CSI is utilized by the signal transmission device to dynamically adapt to the channel conditions by using different parameters, including but not limited to modes as shown in step 612. Performance parameters are recorded and performance is analyzed via post processing as shown in step 614. For example, post processing can include identifying the different modes, identifying transitions between different modes, predicting overall DUT performance, and generation of plots, graphs, histograms and other data records.

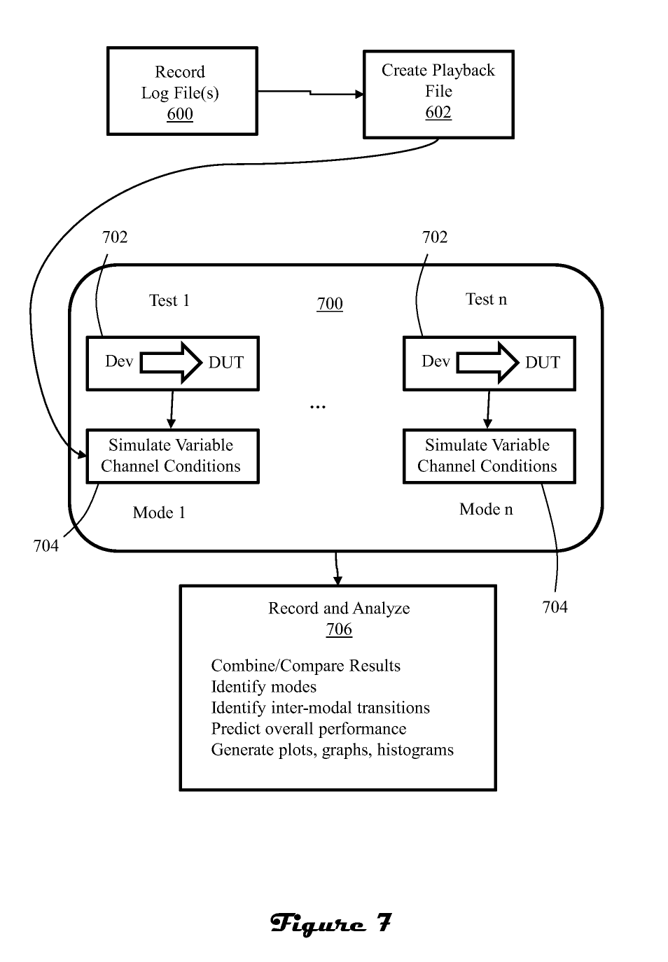

Another method of performing OTA testing is shown in FIG. 7. Initial steps which may be performed priori to testing include recording at least one log file 600 and creating a playback file 602. Multiple tests (Test 1 through Test n) are performed during testing 700. Each test may be performed in a different mode (Mode 1 through Mode n corresponding to Test 1 through Test n). During each test the signal transmission device sends communications to the DUT via the channel emulator as indicated by step 702 while the channel emulator simulates variable channel conditions as indicated by step 704. The DUT may or may not transmit CSI to the signal transmission device based on the received signals. Performance parameters are recorded and performance is analyzed via post processing as indicated in step 706. For example, post processing can include combining and comparing the results of the different tests to compare mode performance and estimate dynamic adaptation, identifying the different modes, identifying transitions between different modes, predicting overall DUT performance, and generation of plots, graphs, histograms and other data records.

It will be appreciated that some signal transmission devices may have the capability of dynamically adapting based on some but not all CSI. In such cases aspects of the methods of both FIG. 6 and FIG. 7 can be utilized. If the signal transmission device has the capability to dynamically adapt based on the CSI then the CSI is utilized by the signal transmission device to dynamically adapt to the channel conditions by using different supported modes. If the signal transmission device does not have the capability to dynamically adapt based on the CSI then the signal transmission device may be manually reconfigured and independent tests may be performed in each mode. The tests may then be compared and combined in order to estimate dynamic adaptation. For example, if the signal transmission device is a device emulator that lacks the ability to dynamically adapt to some or all CSI parameters then the operation of an actual signal transmission device with dynamic adaptation capability can be simulated. Consequently, it may not be necessary to maintain an undesirably large inventory of actual signal transmission devices to support testing.

While aspects described through the above examples, it will be understood by those of ordinary skill in the art that a wide variety of modifications, combinations and variations may be made without departing from the inventive concepts. Further, while particular features are described in connection with various illustrative examples, one skilled in the art will recognize that the features may be used in a wide variety of combinations and the system may be embodied in connection with other examples. Accordingly, the invention should not be viewed as limited except by the scope and spirit of the appended claims.

What is claimed is:

1. Apparatus for testing a wireless device with at least one antenna comprising:
a signal transmission device which transmits test signals having a spatial rank;
a channel emulator which operates on the test signals from the signal transmission device to cause the test signals to exhibit channel conditions which vary over time; and
an over-the-air test chamber including multiple antennas which are driven with the test signals from the channel emulator which exhibit channel conditions, the device under test being disposed in the over-the-air test chamber and sending channel state information to the signal transmission device, the signal transmission device responding to the channel state information by adapting to current channel conditions.

2. The apparatus of claim 1 wherein the over-the-air test chamber is a reverberation chamber, and the driven antennas deployed in the reverberation chamber are greater in number than the spatial rank of the test signals from the multiple antennas being received by the at least one antenna of the wireless device.

3. The apparatus of claim 2 wherein the channel emulator has a greater number of outputs to the driven antennas than inputs from the signal transmission device.

4. The apparatus of claim 3 wherein the channel emulator independently drives the outputs with different fading processes.

5. The apparatus of claim 4 wherein the fading processes are random.

6. The apparatus of claim 2 wherein the antennas are deployed in the reverberation chamber such that no line-of-sight transmission component exists from test system antennas to the at least one antenna of the wireless device under test.

7. The apparatus of claim 2 wherein the antennas are deployed in the reverberation chamber such that there is a line of sight component from at least one test system antenna to the at least one antenna of the wireless device under test.

8. The apparatus of claim 2 wherein the antennas are deployed in the reverberation chamber such that that signals from the antennas are directed away from the device under test.

9. The apparatus of claim 2 wherein the signal transmission device emulates one or more of an actual base station device, a base station emulator, a femtocell, a picocell, a class of base station device, an access point, an access point emulator, or a programmable signal generator.

10. The apparatus of claim 2 wherein the channel emulator provides a dominant Doppler source relative to a Doppler source of the reverberation chamber.

11. The apparatus of claim 10 wherein the Doppler process of the reverberation chamber is in some ratio of the Doppler process of the channel emulator.

12. The apparatus of claim 11 wherein when a desired fading or Doppler velocity is set, the apparatus adjusts the velocity of a stirring process of the chamber to maintain the ratio.

13. The apparatus of claim 2 wherein the signals emanating from the driven antennas are correlated according to settings in the channel emulator.

14. The apparatus of claim 2 wherein the channel emulator provides a statistical representation of channel propagation conditions for evaluation of the wireless device, wherein the conditions include at least one of multipath, correlation, and fading.

15. The apparatus of claim 2 wherein the chamber includes absorbing material which dampens reverberation such that the channel emulator provides the dominant multipath conditions.

16. The apparatus of claim 1 including automated calibration which determines decay of the chamber.

17. The apparatus of claim 1 wherein the signal transmission device is a device emulator.

18. The apparatus of claim 1 wherein a sniffer antenna inside the test chamber enables the wireless device under test to provide the channel state information to the signal transmission device.

19. The apparatus of claim 1 wherein a sniffer antenna inside the test chamber enables the wireless device under test to respond to the test signal by negating effects of the chamber on a signal transmitted by the device under test which are undesirable for the test.

20. The apparatus of claim 1 wherein signal data is analyzed to determine a metric including at least one of throughput, packet loss, error rate, and Channel Quality Information.

21. A method for testing a wireless device with at least one antenna comprising:
generating test signals having a spatial rank;
causing the test signals to exhibit channel conditions which change over time;
driving multiple antennas in an over-the-air test chamber with the test signals from the channel emulator which exhibit channel conditions, the device under test being disposed in the over-the-air test chamber; and
sending channel state information to the signal transmission device, the signal transmission device responding to the channel state information by adapting to current channel conditions.

22. The method of claim 21 wherein the over-the-air test chamber is a reverberation chamber, and including deploying the driven antennas in the reverberation chamber in greater number than the spatial rank of the test signals from the multiple antennas being received by the at least one antenna of the wireless device.

23. The method of claim 22 including utilizing a greater number of channel emulator outputs to the driven antennas than inputs from the signal transmission device.

24. The method of claim 23 including the channel emulator independently driving the outputs with different fading processes.

25. The method of claim 24 including causing the fading processes to be random.

26. The method of claim 22 including deploying the antennas in the reverberation chamber such that no line-of-sight transmission component exists from test system antennas to the at least one antenna of the wireless device under test.

27. The method of claim 22 including deploying the antennas in the reverberation chamber such that there is a line of sight component from at least one test system antenna to the at least one antenna of the wireless device under test.

28. The method of claim 22 including deploying the antennas in the reverberation chamber such that that signals from the antennas are directed away from the device under test.

29. The method of claim 22 including the signal transmission device emulating one or more of an actual base station device, a base station emulator, a femtocell, a picocell, a class of base station device, an access point, an access point emulator, or a programmable signal generator.

30. The method of claim 22 including the channel emulator providing a dominant Doppler source relative to a Doppler source of the reverberation chamber.

31. The method of claim 30 including causing the fading process of the reverberation chamber to be in some ratio of the fading process of the channel emulator.

32. The method of claim 31 including when a desired fading or Doppler velocity is set, adjusting the velocity of a stirring process of the chamber to maintain the ratio.

33. The method of claim 22 including correlating the signals emanating from the driven antennas according to settings in the channel emulator

34. The method of claim 22 including the channel emulator providing a statistical representation of channel propagation conditions for evaluation of the wireless device, wherein the conditions include at least one of multipath, correlation, and fading.

35. The method of claim 22 including providing the chamber with absorbing material which dampens reverberation such that the channel emulator provides the dominant multipath conditions.

36. The method of claim 21 including determining decay of the chamber with automated calibration.

37. The method of claim 21 wherein the signal transmission device is a device emulator.

38. The method of claim 21 including a sniffer antenna inside the test chamber enabling the wireless device under test to provide the channel state information to the signal transmission device.

39. The method of claim 21 including a sniffer antenna inside the test chamber enabling the wireless device under test to respond to the test signal by negating effects of the chamber on a signal transmitted by the device under test which are undesirable for the test.

40. The method of claim 21 including analyzing signal data to determine a metric including at least one of throughput, packet loss, error rate, and Channel Quality Information.

41. Apparatus for testing a wireless device with at least one antenna comprising:
a signal transmission device which transmits test signals having a spatial rank;
a channel emulator which operates on the test signals from the signal transmission device to cause the test signals to exhibit channel conditions which vary over time; and
an over-the-air test chamber including multiple antennas which are driven with the test signals from the channel emulator which exhibit channel conditions, the device under test being disposed in the over-the-air test chamber and undergoing a first test in which the signal transmission device is in a first mode and a second test in which the signal transmission device is in a second mode, results of the tests being used to estimate adaption to current channel conditions.

42. A method for testing a wireless device with at least one antenna comprising:
generating test signals having a spatial rank;
causing the test signals to exhibit channel conditions which change over time;
driving multiple antennas in an over-the-air test chamber with the test signals from the channel emulator which exhibit channel conditions, the device under test being disposed in the over-the-air test chamber;
performing a first test in which the signal transmission device is in a first mode and a second test in which the signal transmission device is in a second mode; and
using results of the tests being used to estimate adaption to current channel conditions.
